(19) United States
(12) Patent Application Publication
(10) Pub. No.: US 2014/0345148 A1
(43) Pub. Date: Nov. 27, 2014

(54) Cutting Blade For Use With Oscillating Power Tool

(71) Applicant: Black & Decker Inc., Newark, DE (US)

(72) Inventors: Thomas R. KAYE, JR., Bel Air, MD (US); James R. NIBLETT, Columbia, MD (US)

(21) Appl. No.: 13/898,967

(22) Filed: May 21, 2013

(51) Int. Cl. B26B 5/00

(52) U.S. Cl. CPC B26B 5/00
USPC 30/356

(57) ABSTRACT

An oscillating cutting blade has a body with an attachment mechanism to couple the oscillating cutting blade with an oscillating tool. The attachment mechanism enables rotation of the body on the oscillating tool. A first cutting surface on the body cuts a workpiece in a pulling direction. A second cutting surface on the body cuts the workpiece in a pushing direction.

### FIELD

The present disclosure relates to cutting blades and, more particularly, to cutting blades for use with oscillating power tools.

### BACKGROUND

Oscillating power tools and cutting blades may be used for cutting various types of materials. Generally, such blades include an attachment portion for attachment to a clamping mechanism of an oscillating power tool, and one or more cutting portions for engaging a workpiece. Most such blades can cut in only one direction, e.g., by pushing or by pulling the oscillating power tool in a direction of the cutting portions.

### SUMMARY

According to a first aspect of the disclosure, an oscillating cutting blade comprises a body with an attachment mechanism to couple the body with an oscillating power tool. The attachment mechanism enables oscillation of the body by the oscillating power tool. The body includes a first cutting surface configured to cut a workpiece in a pulling direction of the oscillating power tool. The body further includes a second cutting surface configured to cut the workpiece in a pushing direction of the oscillating power tool. The body may generally have the shape of a sector of a circle bounded by first, second, and third side edges. The attachment mechanism may be positioned at or near a center of the circle. The first and second side edges may extend generally radially outward from the attachment mechanism. The third side edge may have an arcuate shape partially extending along a circumference of the circle. In one embodiment, the sector comprises approximately a 90° sector of a circle. The first cutting surface comprises a first hook shaped recess formed in the first side edge and intersecting the third edge at a first cutting tip. An inclined surface extends from the first edge towards the first cutting surface. The second cutting surface comprises a second hook shaped recess formed in the third edge and intersecting the second edge at a second cutting tip. The first and second cutting surfaces may be arcuate. The first and second cutting faces include a beveled surface.

According to a second aspect of the disclosure, an oscillating cutting blade comprises a body bound by at least a first, second and third side edge. An attachment mechanism couples the cutting blade to an oscillating power tool. The attachment mechanism enables the body to be removably coupled to the oscillating power tool. The body is to be driven in an oscillating manner by the oscillating power tool. A first cutting surface is formed as a hook-shaped recess generally facing toward the attachment mechanism. A second cutting surface, formed as a hook-shaped recess in the third side edge, intersects generally away from the attachment mechanism. The body has a shape of a sector of a circle bound by the first, second and third side edges. The first and second side edges extend generally radially outward from the attachment mechanism. The third side edge has a generally arcuate shape partially extending along a circumference of the circle.

According to a third aspect of the disclosure, an oscillating cutting blade comprises a body bound by at least a first, second and third side edge. An attachment mechanism couples the body with an oscillating power tool. The attachment mechanism enables the body to be removably coupled to the oscillating power tool and to be driven in an oscillating manner by the oscillating power tool. The body first and second side edges each have a proximal end portion adjacent the attachment mechanism. A distal end portion is positioned further away from the attachment mechanism. The third side edge extends between the distal end portions of the first and second side edges. A first cutting surface is formed as a hook-shaped recess in a distal portion of the first edge and intersects the third edge at a first cutting tip. A second cutting surface is formed as a hook-shaped recess in the third side edge and intersects a distal end portion of the second edge at a second cutting tip. The body generally has a shape of a sector of a circle bounded by the first, second, and third side edges. The first and second side edges extend generally radially outward from the attachment mechanism. The third side edge has a generally arcuate shape partially extending along a circumference of the circle.

The present oscillating cutting blade provides the art with a blade that is capable of cutting various materials such as asphalt shingles, carpet, linoleum, cardboard and the like. The blade includes a plurality of cutting edges. The blade can, for example, cut asphalt shingles through the grit side of the shingle. Additionally, the blade provides for use in both a push or pull direction.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view of an oscillating cutting blade in accordance with the disclosure.

FIG. 2 is a side elevation view of the cutting blade of FIG. 1.

FIG. 3 is a cross-section view along line 3-3 of FIG. 1 thereof.

FIG. 4 is an enlarged view of the first cutting surface.

FIG. 5 is an enlarged view of the second cutting surface.

FIG. 6 is a perspective view of the oscillating cutting blade of FIG. 1 coupled to an oscillating power tool and being used to cut a workpiece with the first cutting surface in a pulling direction.

FIG. 7 is a perspective view of the oscillating cutting blade of FIG. 1 coupled to an oscillating power tool and being used to cut a workpiece with the second cutting surface in a pushing direction.

### DETAILED DESCRIPTION

Example embodiments will now be described more fully with reference to the accompanying drawings.

Turning to the figures, an oscillating cutting blade is illustrated and designated with the reference numeral 10. The oscillating cutting blade 10 includes a body 12 having an attachment mechanism 14, a first cutting surface 16 and a second cutting surface 18. The attachment mechanism 14 enables cutting blade 10 to be removably coupled to an oscillating power tool 50 so that the blade can oscillate relative to the power tool 50. The illustrated attachment mechanism is similar to one of the attachment mechanisms disclosed in Applicant's pending U.S. patent application Ser. No. 13/781,900 entitled “Universal Accessory for Oscillating Power Tools”, filed Mar. 1, 2013, the specification and drawings of which are hereby incorporated by reference. The attachment mechanism may have a plurality of alternative configurations such as one of the other attachment mechanism disclosed in the aforementioned applications, or a wide array of other attachment mechanisms, which may enable the oscillating blade to one or more types of oscillating power tools.

The body 12 generally has the shape of a sector of a circle, with the sector bounded by a first side edge 20, a second side edge 22, and a third side edge 24. The attachment mechanism 14 is positioned roughly at or near a center of the circle defined by the sector-shaped body 12. The first and second side edges 20, 22 extend generally radially outward from the attachment mechanism 14. The third side edge 24 has an arcuate shape that extends partially along a circumference of the circle defined by the sector. In one embodiment, the sector comprises approximately an overall approximately 90° sector design. The body 12 is substantially flat and planar. The body is generally manufactured from a steel material, such as hardened spring steel (e.g., SK5 steel), although other suitable materials may be used. The body generally has a hardness of approximately 45 HRC to approximately 50 HRC.

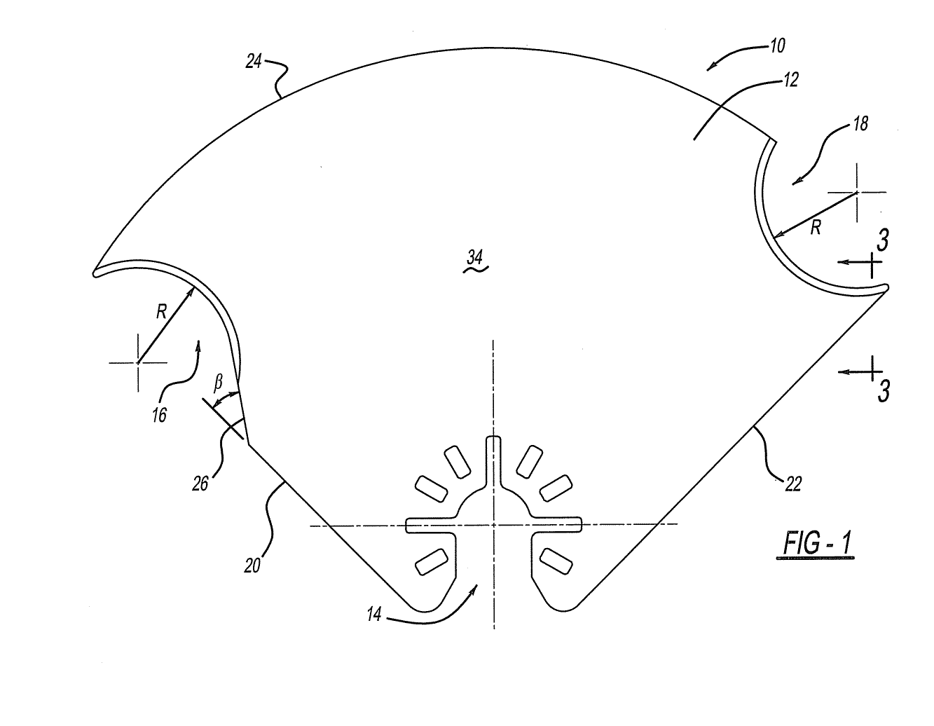

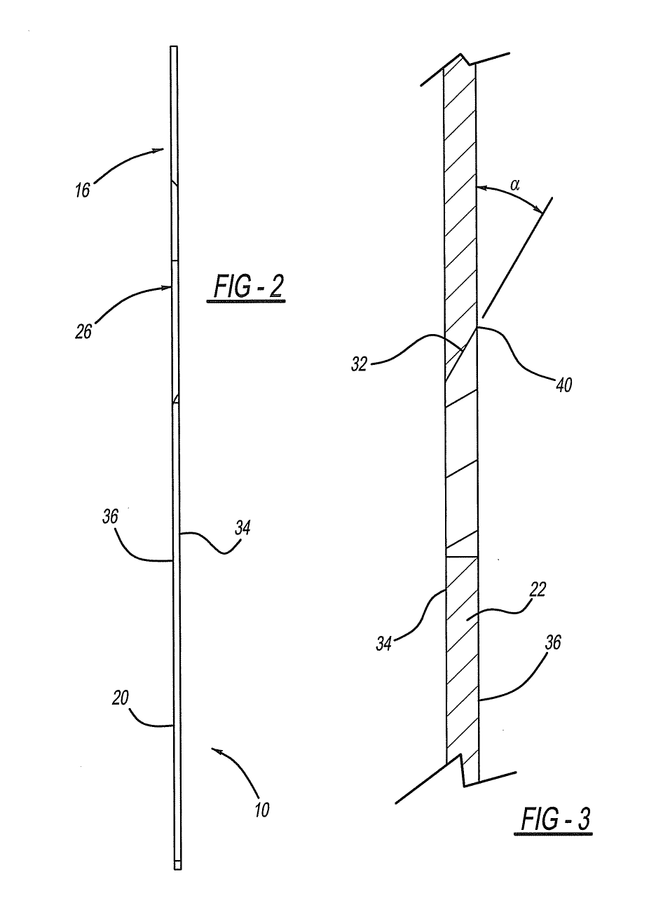

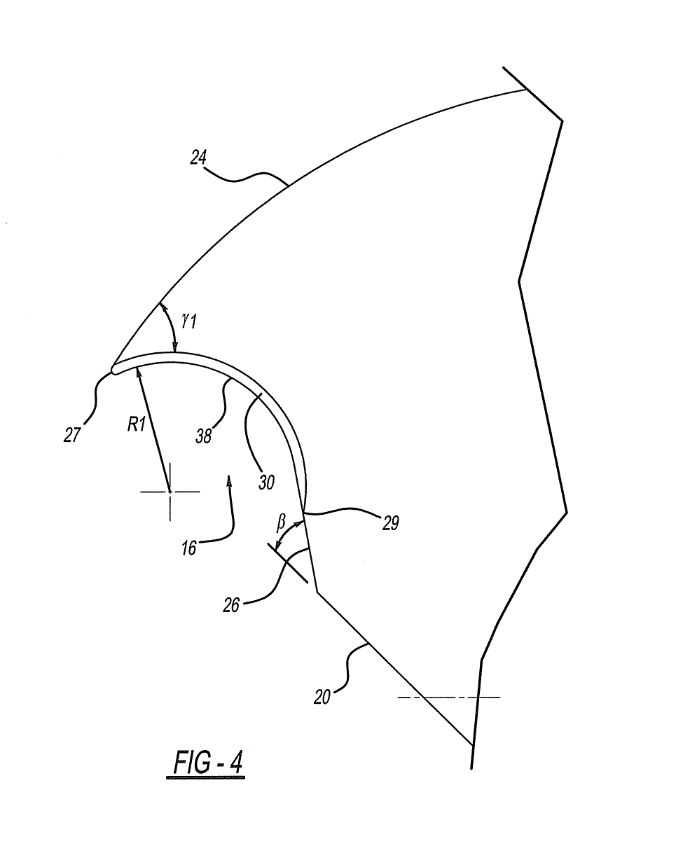

Referring to FIG. 4, the first cutting surface 16 comprises a first hook shaped cutting surface formed in the first side edge 20 and intersecting the third edge 24 at a first cutting tip 27. As shown in FIG. 1, the first cutting surface 16 and cutting tip 27 face generally toward the attachment mechanism 14. The first edge 20 includes an inclined portion 26 that extends inward from the first edge 20 to an origin 29 of the first cutting surface 16. The inclined portion 26 is on a desired angle β relative to the first edge 20, which can be between approximately 30° and approximately 40°, for example, 35°. The inclined portion 26 enables the first cutting surface 16 to enter a workpiece (material to be cut) so that the oscillating blade 16 may be moved in a pulling direction, as discussed further below. This enables easy access to the workpiece by the oscillating cutting blade 10.

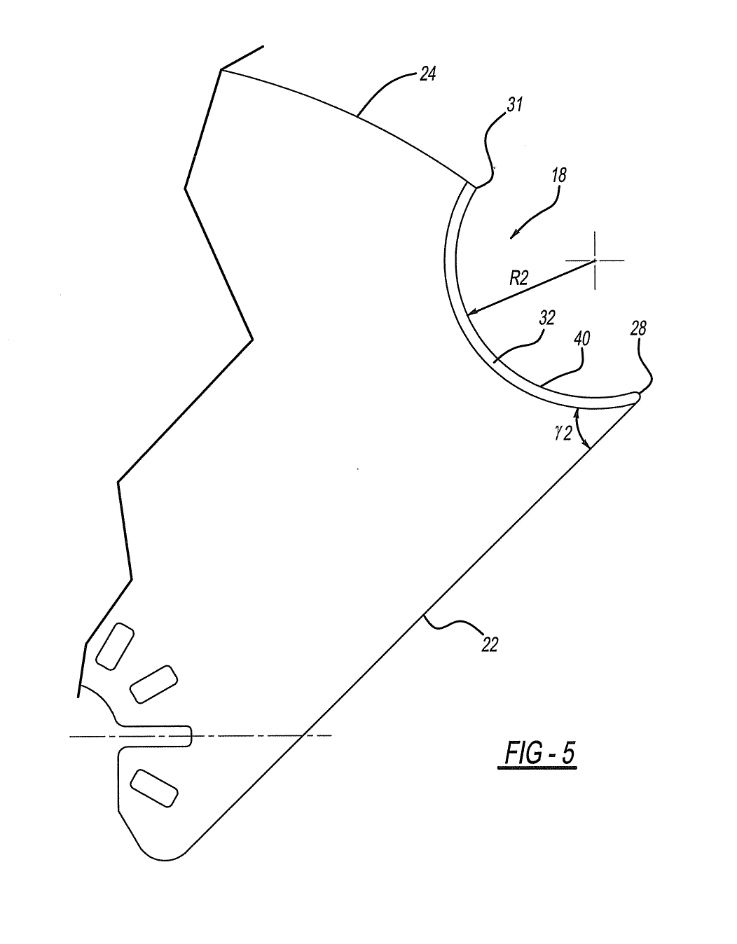

Referring to FIG. 5, the second cutting surface 18 comprises a second hook shaped cutting surface formed in the third edge 24 and intersecting the second edge 22 at a second cutting tip 28. As shown in FIG. 1, the second cutting surface 18 faces generally away from the attachment mechanism 14. The third edge 24 is joined with and terminates at an origin 31 of the second cutting surface 18. The second edge 22 forms the second cutting tip 28 with the second cutting surface 18. This configuration enables the second cutting surface 18 to cut material in a pushing direction of the oscillating power tool, as discussed in greater detail below.

The cutting surface 16 is arcuate and has a desired radius (R1). The radius (R1) is between approximately 10 mm and approximately 20 mm, for example 14 mm. The arc portion of the first cutting surface 16 has a circumferential length between approximately 100° and approximately 150°, for example, between approximately 125° and approximately 130°. The cutting surface 16 includes a beveled surface 30. The beveled surface extends at an angle of between approximately 25° and approximately 35°, for example, approximately 30°, with respect to the horizontal, as illustrated in FIG. 3 and is designated with the a designation. The beveled surface 30 with the bottom body surface 36 forms arcuate cutting edge 38. The cutting edge 38 enhances the cutting performance of the cutting surfaces 16. As illustrated in FIG. 1, the beveled surface 30 extends in the same direction as beveled surface 32, although it should be understood that they may be beveled in opposite directions. In the illustrated example, the beveled surface 30 is beveled towards the top body surface 34.

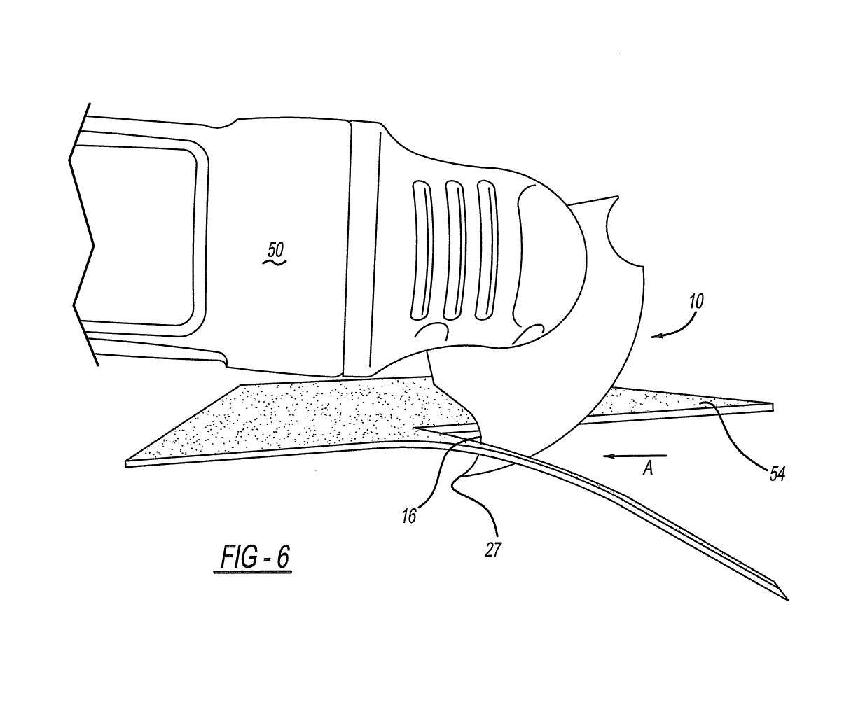

The first cutting tip 27 is angled with respect to the edge 22 on an angle γ1 between approximately 30° and approximately 40°, for example approximately 35°. This angle enhances the cutting of the workpiece during a pulling force applied onto the cutting tip 27 of the oscillating blade, as shown in FIG. 6. Also, the angle enables the cutting tip 27 to puncture through the workpiece to start the cutting in a pulling direction. Thus, the arcuate cutting edge 38 cuts through the workpiece when the oscillating blade 10 is in use on an oscillating tool.

The cutting surface 18 is arcuate and has a desired radius (R2). The radius (R2) is between approximately 10 mm and approximately 20 mm, for example, 14 mm. The arc portion of the second cutting surface 18 has a circumferential length between approximately 120° and approximately 180°, for example, between approximately 135° and 140°. The cutting surface 18 includes a beveled surface 32. The beveled surface extends at an angle of between approximately 25° and approximately 35°, for example approximately 30°, with respect to the horizontal, as illustrated in FIG. 3 and is designated with the a designation. The beveled surface 32, with the bottom body surface 36, forms the arcuate cutting edge 40. The cutting edge 40 enhances the cutting performance of the cutting surfaces 18. As illustrated in FIG. 1, the beveled surface 32 extends in the same direction as beveled surface 30, although it should be understood that they may be beveled in opposite directions. In the illustrated example, the beveled surface 32 is beveled towards the top body surface 34.

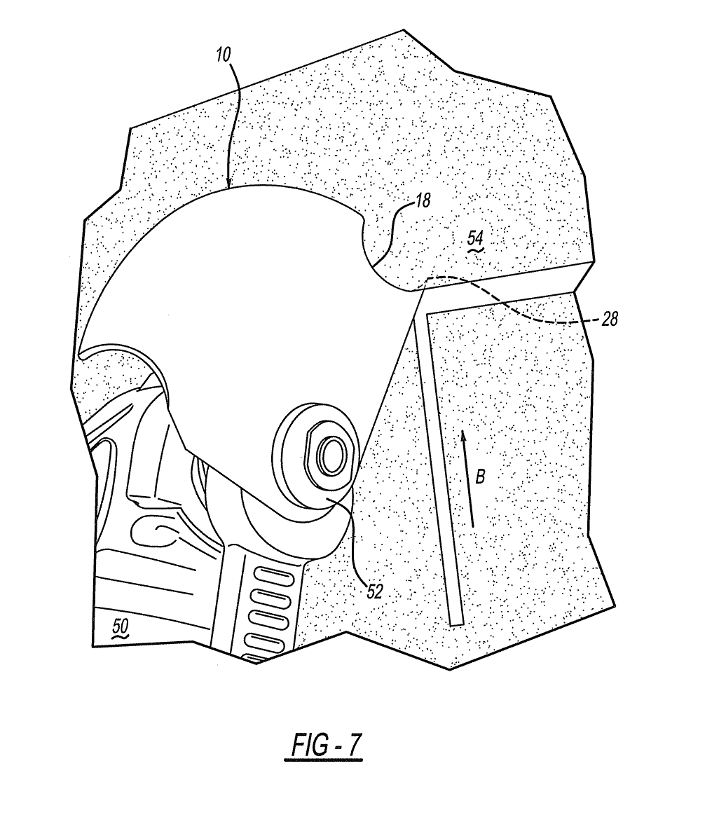

The second cutting tip 28 is angled with respect to the edge 22 on an angle γ2 between approximately 25° and approximately 35°, for example, between approximately 29° and approximately 33°. This angle enhances the cutting of the workpiece during a pushing force applied onto the cutting tip 28 of the oscillating blade as shown in FIG. 7. Also, the angle enables the cutting tip 28 to puncture through the workpiece to start the cutting in a pushing direction. Thus, the arcuate cutting edge 40 cuts through the workpiece when the oscillating blade 10 is in use on an oscillating tool.

Turning to FIGS. 6 and 7, an oscillating power tool is illustrated and designated with the reference numeral 50. The oscillating power tool 50 is coupled with the oscillating blade 10 via the attachment mechanism 14 as illustrated in FIG. 7. A clamp mechanism 52 secures the oscillating blade 10 with the oscillating power tool 50. The clamp mechanism may be configured similar to the clamp mechanisms described in commonly owned U.S. patent application Ser. No. 13/362,637 filed on Jan. 31, 2012, which is incorporated by reference. Alternatively, the clamp mechanism may be configured similar to other known clamping mechanisms in the art.

As seen in FIG. 6, the first cutting surface 16 of blade 10 is utilized in a pulling direction A to cut through a workpiece 54, illustrated as a shingle. Here, the tip 27 could puncture the workpiece 54 or the cutting surface 16 could be directly applied into contact with the workpiece 54, followed by pulling the oscillating tool 50 in the direction A.

FIG. 7 illustrates the second cutting surface 18 of oscillating blade 10 cutting through the workpiece 54, such as shingle, in the pushing direction B. Here, the cutting tip 28 can be used to puncture the workpiece 54 and the cutting surface 18 is pushed in the direction B while in contact with the workpiece 54. Thus, the oscillating cutting blade 10 can be utilized in both a pushing and pulling direction when it is connected with the oscillating power tool 50.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. For example, the first, second, and/or third edges may include additional teeth and/or cutting surfaces. The body may have a shape or configuration other than the shape of a sector of a circle (e.g., generally triangular, quadrilateral, hexagonal, circular, oval, etc.). The first and second cutting surfaces may have different shapes, configurations, and sizes. The inclined surface 26 may be eliminated. The same may also be varied in many ways. Such variations are not to be regarded as a departure from the disclosure, and all such modifications are intended to be included within the scope of the disclosure.

What is claimed is:

1. An oscillating cutting blade comprising:
a body generally having a shape of a sector of a circle bounded by first, second, and third side edges;
an attachment mechanism for coupling with an oscillating power tool, the attachment mechanism enabling the body to be removably coupled to the oscillating power tool to be driven in an oscillating manner by the oscillating power tool;
a first cutting surface on the body, the first cutting surface configured to cut a workpiece in a pulling direction; and
a second cutting surface on the body, the second cutting surface configured to cut the workpiece in a pushing direction.

2. The oscillating cutting blade of claim 1, wherein the attachment mechanism is positioned approximately near a center of the circle that defines the sector.

3. The oscillating cutting blade of claim 1, wherein the first and second side edges extend generally radially outward from the attachment mechanism.

4. The oscillating blade of claim 1, wherein the third side edge has a generally arcuate shape partially extending along a circumference of the circle.

5. The oscillating cutting blade of claim 1, wherein the body has an overall approximately 90° sector design.

6. The oscillating cutting blade of claim 1, wherein the first cutting surface comprises a first hook shaped recess formed in the first side edge and intersecting the third edge at a first cutting tip.

7. The oscillating cutting blade of claim 6, wherein an inclined surface extends from the first edge of the body to intersect an origin of the first cutting surface.

8. The oscillating cutting blade of claim 1, wherein the second cutting surface comprises a second hook shaped recess formed in the third edge and intersecting the second edge at a second cutting tip.

9. The oscillating cutting blade of claim 8, wherein the second cutting surface originates on the third edge of the body.

10. The oscillating cutting blade of claim 1, wherein each of the first and second cutting surfaces is arcuate.

11. The oscillating cutting blade of claim 1, wherein each of the first and second cutting surfaces include a beveled surface.

12. The oscillating cutting blade of claim 1, wherein each of the first and second cutting surfaces include a cutting tip.

13. An oscillating cutting blade comprising:
a body generally having a shape of a sector of a circle bounded by at least first, second, and third side edges;
an attachment mechanism for coupling with an oscillating power tool, the attachment mechanism enabling the body to be removably coupled to the oscillating power tool to be driven in an oscillating manner by the oscillating power tool;
a first cutting surface formed as a first hook-shaped recess facing generally toward the attachment mechanism; and
a second cutting surface formed as a second hook-shaped recess facing generally away from the attachment mechanism.

14. The oscillating blade of claim 13, wherein the first hook-shaped recess is formed in the first edge, and the second hook-shaped recess is formed in the third edge.

15. The oscillating cutting blade of claim 14, wherein the first and second side edges extend generally radially outward from the attachment mechanism.

16. The oscillating blade of claim 13, wherein the third side edge has a generally arcuate shape partially extending along a circumference of the circle.

17. An oscillating cutting blade comprising:
a body bounded by at least first, second, and third side edges;
an attachment mechanism for coupling with an oscillating power tool, the attachment mechanism enabling the body to be removably coupled to the oscillating power tool to be driven in an oscillating manner by the oscillating power tool,
the body first and second side edges each having a proximal end portion adjacent the attachment mechanism and a distal end portion positioned further away from the attachment mechanism, the third side edge extending between the distal end portions of the first and second side edges;
a first cutting surface formed as a hook-shaped recess in a distal portion of the first edge and intersecting the third edge at a first cutting tip; and
a second cutting surface formed as a hook-shaped recess in the third side edge and intersecting a distal end portion of the second edge at a second cutting tip.

18. The oscillating cutting blade of claim 17, wherein the body generally has a shape of a sector of a circle bounded by the first, second, and third side edges.

19. The oscillating cutting blade of claim 18, wherein the first and second side edges extend generally radially outward from the attachment mechanism.

20. The oscillating cutting blade of claim 18, wherein the third side edge has a generally arcuate shape partially extending along a circumference of the circle.
